(19) United States
(12) Patent Application Publication
(10) Pub. No.: US 2025/0276595 A1
(43) Pub. Date: Sep. 4, 2025

(54) Charging Device Station for an Electric Motor Vehicle

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 19/209,826

(22) Filed: May 16, 2025

Related U.S. Application Data
(62) Division of application No. 17/641,120, filed on Mar. 8, 2022.

(51) Int. Cl. B60L 53/31; B60L 53/54; B60L 53/57

(52) U.S. Cl. CPC B60L 53/31; B60L 53/54; B60L 53/57

(57) ABSTRACT

The invention also relates to a method for generating a charging current for charging electric vehicles with the method steps of feeding a liquid energy carrier from a tank arranged in a housing of a charging column to a first device for energy conversion, wherein the first device for energy conversion is also arranged in the housing, converting the liquid energy carrier into a kinetic or an electrical energy in the first device for energy conversion, converting the kinetic or the electrical energy into a current in a second device for energy conversion, wherein the second device for energy conversion is arranged in the housing, and outputting the current to an electric vehicle.

### CROSS-REFERENCE TO RELATED APPLICATION

This is a divisional of U.S. patent application Ser. No. 17/641,120, filed Mar. 8, 2022, which is the U.S. National Stage of International Patent Application No. PCT/EP2019/074092 filed on Sep. 10, 2019, contents of which are incorporated by reference herein in their entirety.

The invention relates to a charging column for charging electric vehicles, which has a housing, a first device for energy conversion, a second device for energy conversion, a control unit, and a tank for a liquid energy carrier, wherein both units for energy conversion, the tank, and the control unit are arranged in the housing. The invention also relates to a method for generating a charging current for charging electric vehicles with the method steps of feeding a liquid energy carrier from a tank arranged in a housing of a charging column to a first device for energy conversion, wherein the first device for energy conversion is also arranged in the housing, converting the liquid energy carrier into a kinetic or an electrical energy in the first device for energy conversion, converting the kinetic or the electrical energy into a current in a second device for energy conversion, wherein the second device for energy conversion is arranged in the housing, and outputting the current to an electric vehicle.

### FIELD

With the prevalence of electric vehicles, which are operated with an electric motor, a functioning infrastructure for charging the electric vehicles must be made available. In addition to charging at household sockets, the users of electric vehicles must also be given the opportunity to obtain energy in public areas. With the ranges that have been available with electric vehicles up to now, it must also be possible to charge the vehicles outside of the household environment. Therefore, charging stations must be made available in public areas in order to ensure constant availability of energy for electric vehicles through a supply network.

### BACKGROUND

Stationary systems for the electrical supply of stationary charging columns to recharge the traction battery of a plug-in vehicle-hybrid or electric vehicle—are known, for example, in DE 10 2009 016 505 A1. The charging column itself is connected to a power rail of the power supply. An existing power grid has a connecting element for outputting electrical energy to an electric vehicle.

Such a charging device has the disadvantage that it cannot be flexibly erected or taken down. The costs for setting up and in particular connecting the charging device to the existing power grid are also very high. Therefore, if the charging device is only intended to remain at the current location temporarily, erecting it and taking it down cause unnecessarily high costs. Charging devices that are designed to be portable can be used more flexibly.

The patent “DE 10 2010 043 516 A1—Device for Fast Charging of an Electrical Energy Store of a Vehicle” from the company Power Innovation Stromversorgungstechnik GmbH discloses a device for exchanging electrical energy. The device has an electrical energy store (battery), which charges the energy store of the vehicle via a programmable control and an AC/DC converter. The energy store of the device itself is charged via various direct current sources. All components (energy store, control, converter) are arranged in an apparatus, the direct current source for charging the energy store externally and remote from the apparatus.

This charging device has the disadvantage that it is so large and heavy that it can only be set up and operated on large areas, for example in parking lots of shopping centers. Its use in, for example, parking garages is not possible. A connection to an existing power grid is also necessary.

The utility model publication “DE 20 2010 011 567 U1—Mobile Power Station” from the company Beton-und Energietechnik Heinrich Gräper GmbH & Co. KG discloses a portable power station that is arranged inside a portable station building. The building has multiple rooms and consists of concrete. Fuel cell modules, storage containers for the fuel (hydrogen, methane, biogas), and an inverter are arranged in the building. In addition, the building has a photovoltaic system for self-supply.

This charging device is also very large and heavy. At least one truck is required to transport it.

The patent “DE 10 2017 207 023 B4—Charging System and Method for Operating a Charging System” from the company AUDI AG discloses a charging system that has a portable charging station. The charging station has a generator that is operated by means of a synthetic fuel. Excess energy is stored in an intermediate storage apparatus (battery) which is arranged in the charging station. The fuel itself is produced in an external fuel production apparatus. Here, the fuel is synthesized from the carbon dioxide in the atmosphere by means of renewable energy sources.

This charging device requires synthetic fuel to operate, which is currently not available or only available in small amounts and is therefore very expensive. Operating the charging device is therefore also very expensive; a supply of the required synthetic fuel is not guaranteed.

### SUMMARY

It is therefore the object of the present invention to provide a charging device for motor vehicles that is designed so compact and light that it can be set up and operated nearly anywhere and taken down again quickly and easily as needed.

It is also the object of the present invention to provide a charging device for motor vehicles that is designed so compact that it is more cost-effective in production, installation, and operation than previously known charging devices and that works independently.

The above-mentioned object is achieved by means of the charging column according to claim 1. Further advantageous designs of the invention are set out in the dependent claims.

The charging column according to the invention for charging electric vehicles has a first device for energy conversion and a second device for energy conversion. In addition, the charging column has a tank for a liquid energy carrier and a control unit. According to the invention, both devices for energy conversion, the tank, and the control unit are advantageously installed in a housing.

The dimensions of the charging column are very compact and it can be transported, erected, operated, and taken down again as a single part. In particular in rural areas, the charging column according to the invention offers advantages compared to conventional charging columns that must be connected to an existing power grid: The costs of the charging column and thus the investments for installation and operation are low. If the charging column cannot be operated profitably at the chosen location, it can be easily taken down. It can also be removed quickly and set up at a different, more suitable place in the case of construction work in the immediate vicinity of the charging column.

In a further advantageous embodiment of the invention, the first device for energy conversion is suitable for converting a liquid energy carrier into electrical and/or kinetic energy. A combustion engine drives the second device for energy conversion through rotation. The kinetic energy generated by the combustion engine is thus converted into electrical energy by the second device for energy conversion. When using a fuel cell as the first device, the fuel cell generates electrical energy directly.

In a further design of the invention, the liquid energy carrier is methanol, ethanol, or hydrogen. Both types of fuel can be produced in an environmentally friendly way from biomass, have long been established as fuels worldwide, and are thus affordably available. Transporting and storing them as well as their operation are comparable to conventional gasoline and therefore unproblematic.

In a particularly advantageous embodiment of the invention, the first and the second device for energy conversion are a fuel cell with a power converter or a combustion engine with a generator. The combustion engine is usually a piston combustion engine, but other structural designs are also possible. The generator generates electrical energy as current through rotation. A power converter converts, if applicable, the current generated by the generator into a direct current and adjusts the voltage of the direct current. A fuel cell generates electrical energy directly in the form of a current; a power converter and/or current transformer converts, if applicable, the generated current into a direct current with an minimum voltage.

In another aspect of the invention, the charging column has an electrical energy store. The energy store supplies the control unit and, if applicable, a lighting system with energy and starts the first device for energy conversion. The electrical energy store is advantageously designed to be rechargeable.

In a further embodiment of the invention, the electrical energy store is connected such that it can start up a device for conveying the liquid energy carrier to the first device for energy conversion. To operate the first device for energy conversion, it is necessary to convey the fuel from the tank to the first device for energy conversion. This is usually done by a commercially available fuel pump. The fuel pump is supplied with energy by the electrical energy store.

In a particularly advantageous design of the invention, the charging column is suitable for generating power without energy being fed in from outside the charging column. The charging column is very compact due to the implementation of all of its individual components and does not require a connection to an existing power grid. The charging column can be transported, erected, operated, and taken down again as a single part. The costs of the charging column and thus the investments for installation and operation are low. If the charging column cannot be operated profitably at the chosen location, it can be easily taken down. It can also be removed quickly and set up at a different, more suitable place in the case of construction work in the immediate vicinity of the charging column.

In a development of the invention, the charging column has exclusively one or more electrical connections that are suitable for charging electric vehicles. The electrical energy generated in the charging column is output to a motor vehicle via one or more electrical connections (charging cables). The charging column has no other electrical connections outside of the housing. Therefore, the charging column does not require a connection to an existing power grid. The costs of the charging column and thus the investments for installation and operation are low.

In a further embodiment of the invention, the charging column has exclusively lines and/or connections that are suitable for conducting electrical energy out of the charging column. The electrical energy generated in the charging column is output to a motor vehicle via one or more electrical connections (charging cables). The charging column has no other electrical connections outside of the housing. Therefore, the charging column does not require a connection to an existing power grid. The costs of the charging column and thus the investments for installation and operation are low.

In a further embodiment of the invention, the tank is designed such that it holds at least 100 l of the liquid energy carrier, preferably 200 l, and particularly preferably 500 l. The volume of the tank is dimensioned so that at least 10 charging processes (tank contents 100 l) are possible. The tank volume can be adjusted according to the requirements, which are determined by the location at which the charging column is erected. It is thus practical, for example, to choose a small tank volume in large cities, because the infrastructure for refilling is good and the charging column can thus be refilled very quickly. In rural areas, a larger tank volume is chosen in order to increase the intervals between the individual refill processes.

In a further design of the invention, the tank has a volume for receiving an amount of a liquid energy carrier with an energy of at least 125 kWh, preferably 440 kWh, and particularly preferably 2000 kWh. The volume of the tank is dimensioned so that at least 10 charging processes (tank contents 125 kWh) are possible. The tank volume can be adjusted according to the requirements, which are determined by the location at which the charging column is erected. It is thus practical, for example, to choose a small tank volume in large cities, because the infrastructure for refilling is good and the charging column can thus be refilled very quickly. In rural areas, a larger tank volume is chosen in order to increase the intervals between the individual refill processes.

The above-mentioned object is also achieved by means of the method according to the invention for generating a charging current for charging electric vehicles according to claim 10.

The method according to the invention for generating a charging current for charging electric vehicles has five method steps: In the first method step, a liquid energy carrier is fed into a tank arranged in a housing. The tank can be filled, for example, by means of a filling vehicle.

In a second method step, a liquid energy carrier is fed from a tank into the first device for energy conversion. The tank and the first device for energy conversion are arranged in a housing. The charging process begins when a user plugs the electrical connection (charging cable) into the corresponding socket of the motor vehicle to be charged. Then the fuel is fed from the tank to the first device for energy conversion by means of, for example, a fuel pump and the device is started up.

In the third method step, the liquid energy carrier is converted into kinetic or electrical energy in the first device for energy conversion. Depending on the design of the first device for energy conversion (combustion engine or fuel cell), the chemical energy stored in the fuel is converted into kinetic energy in the combustion engine; a fuel cell converts the chemical energy stored in the fuel into a direct current.

In the fourth method step, the electrical or kinetic energy that was generated by means of the first device for energy conversion is converted into a direct current in the second device for energy conversion. When using a combustion engine as the first device for energy conversion, the combustion engine drives the second device for energy conversion, for example a generator, through rotation. The kinetic energy generated by the combustion engine is thus converted into electrical energy, into a current, by the generator. When using a fuel cell, the generated direct current is converted into a direct current with a minimum voltage by means of a power converter. The second device for energy conversion can be designed as a power converter and/or current transformer accordingly.

In the fifth method step, the current that was generated in the second device for energy conversion is output to an electric vehicle. The dimensions of the charging column are very compact and it can be transported, erected, operated, and taken down again as a single part. In particular in rural areas, the charging column according to the invention offers advantages compared to conventional charging columns that must be connected to an existing power grid: The costs of the charging column and thus the investments for installation and operation are low. If the charging column cannot be operated profitably at the chosen location, it can be easily taken down. It can also be removed quickly and set up at a different, more suitable place in the case of construction work in the immediate vicinity of the charging column.

In a further embodiment of the invention, a device for conveying the liquid energy carrier to the first device for energy conversion is started up by an electrical energy store. To operate the first device for energy conversion, it is necessary to convey the fuel from the tank to the first device for energy conversion. This is usually done by a commercially available fuel pump. The fuel pump is supplied with energy and started by the electrical energy store.

In a further design of the invention, the liquid energy carrier is fed to the first device for energy conversion by the charging of an electrical energy store. To operate the first device for energy conversion, it is necessary to convey the fuel from the tank to the first device for energy conversion. This is usually done by a commercially available fuel pump. The fuel pump is supplied with energy and started by the electrical energy store.

In a further advantageous embodiment of the invention, electrical energy is transported exclusively from the charging column to outside the charging column. The electrical energy generated in the charging column is output to a motor vehicle via one or more electrical connections (charging cables). The charging column has no other electrical connections outside of the housing. Therefore, the charging column does not require a connection to an existing power grid. The costs of the charging column and thus the investments for installation and operation are low.

In a development of the invention, the generation of the electrical energy in the charging column begins with the beginning of the charging process. If the charging column is not in operation, it is in standby mode. The operation of the charging column begins only upon the request of a user, usually in that the user plugs the electrical connection (charging cable) into the electrical connection of the motor vehicle to be charged. In standby mode, the charging column itself consumes very little energy.

In a further aspect of the invention, the generation of the electrical energy in the charging column ends with the end of the charging process. The charging process ends when the user releases the charging cable from the motor vehicle to be charged, or when the energy store of the motor vehicle is charged sufficiently (e.g., 80% of the capacity of the energy store or more). After the charging process is terminated, the first device for energy conversion is stopped and no more fuel is conveyed to the first device for energy conversion. The charging column enters a standby mode until the beginning of the next charging process.

In a further design of the invention, the feeding of a liquid energy carrier from a tank arranged in a housing of a charging column to a first device for energy conversion does not take place simultaneously with the feeding of a liquid energy carrier into a tank arranged in a housing of a charging column. The tank is filled at a different point in time than the charging process on one hand for safety reasons and on the other hand in order not to interrupt a charging process. This increases the service quality for a user.

In a further embodiment of the invention, multiple charging processes take place between two processes for feeding a liquid energy carrier into a tank arranged in a housing of a charging column. The volume of the tank is dimensioned such that multiple charging processes are possible. The control unit can send a signal, for example, an SMS or email, to the operator of the charging column when the tank contents have fallen below a specific previously established volume.

In a further design of the invention, a volume of a liquid energy carrier with an energy of at least 125 kWh, preferably 440 kWh, and particularly preferably 2000 kWh is fed to the tank arranged in a housing of a charging column. The volume of the tank is dimensioned so that at least 10 charging processes (tank contents 125 kWh) are possible. The tank volume can be adjusted according to the requirements, which are determined by the location at which the charging column is erected. It is thus practical, for example, to choose a small tank volume in large cities, because the infrastructure for refilling is good and the charging column can thus be refilled very quickly. In rural areas, a larger tank volume is chosen in order to increase the intervals between the individual refill processes.

In a further embodiment of the invention, at least 100 l of the liquid energy carrier, preferably 200 l, and particularly preferably 500 l, are fed to the tank arranged in a housing of a charging column. The volume of the tank is dimensioned so that at least 10 charging processes (tank contents 100 l) are possible. The tank volume can be adjusted according to the requirements, which are determined by the location at which the charging column is erected. It is thus practical, for example, to choose a small tank volume in large cities, because the infrastructure for refilling is good and the charging column can thus be refilled very quickly. In rural areas, a larger tank volume is chosen in order to increase the intervals between the individual refill processes.

### BRIEF DESCRIPTION OF THE DRAWINGS

Exemplary embodiments of the charging column according to the invention for charging electric vehicles and of the method according to the invention for generating a charging current for charging electric vehicles are shown in the drawings in a schematically simplified manner and are explained in more detail in the following description. The figures show:

FIG. 1: An exemplary embodiment of the charging column according to the invention with a combustion engine

FIG. 2: An exemplary embodiment of the charging column according to the invention with a fuel cell

FIG. 3: An exemplary embodiment of the method according to the invention for charging electric vehicles

### DETAILED DESCRIPTION

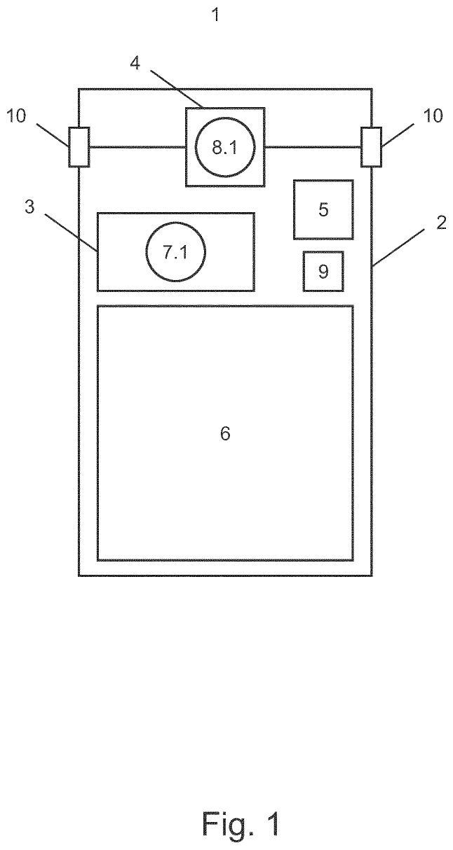

FIG. 1 shows an exemplary embodiment of the charging column 1 according to the invention. In this exemplary embodiment, the charging column 1 has a combustion engine 7, which is installed inside the first device for energy conversion 3. The combustion engine 7 is usually a piston combustion engine, but other structural designs such as a rotary engine or turbine are also possible. The combustion engine 7 is advantageously preferably operated with methanol or ethanol or a mixture of methanol and ethanol. Both types of fuel can be produced in an environmentally friendly way from biomass, have long been established as fuels worldwide, and are thus affordably available. Transporting and storing them as well as their operation in combustion engines are comparable to conventional gasoline (for motor vehicles) and therefore unproblematic. The fuel is stored in the charging column 1 according to the invention in a tank 6 with a capacity of 100 l. The combustion engine 7 drives the second device for energy conversion 3 through rotation, in this exemplary embodiment a generator 8. The kinetic energy generated by the combustion engine 7 is thus converted into electrical energy, into a current, by the generator 8.

Furthermore, an electrical energy store (rechargeable battery) 9 and a device for conveying the liquid energy carrier 11 are installed in the charging column 1. The energy store 9 supplies the control unit 5, by means of which the charging column 1 detects and initializes the beginning and the termination of a charging process. In addition, a user can pay for the charging process by means of the control unit 5. Multiple payment systems are possible here, for example, via various credit cards or via a mobile end device, e.g., a smartphone.

The electrical energy store 9 starts via a starter and the fuel pump 11, which conveys the fuel into the combustion engine 7, also starts the combustion engine 7 at the beginning of a charging process. The electrical energy store 9 is charged, if applicable, by the electrical energy generated by the generator 8. The electrical energy generated in the charging column 1 is output to a motor vehicle via one or more electrical connections 10 (charging cables).

The first and the second device for energy conversion 3, 4 with the combustion engine 7 and generator 8, tank 6, energy store 9, the fuel pump 11, control unit 5, and the electrical connections 10 are all advantageously installed in a housing 2. As described, the charging column 1 is to be operated fully independently, i.e., it does not require an electrical connection to an existing power grid. The required electrical energy for its operation is delivered by the rechargeable energy store 9. The dimensions of the charging column 1 are also very compact; the fuel pump 6 usually takes up the most space. By suitably choosing the size of the tank 6, the dimensions of the charging column 1 can be kept small; however, it may then be necessary to fill the tank 6 with fuel often. For this purpose, the control unit 5 is advantageously connected to the operator of the charging column 1 via WLAN or similar communication apparatuses and outputs a corresponding message when the tank 6 needs to be refilled.

The method according to the invention for generating a charging current for charging electric vehicles has five method steps: In the first method step 100, a liquid energy carrier, in this exemplary embodiment methanol obtained from biomass, is fed into a tank 6 arranged in a housing. The tank 6 is filled by means of a filling vehicle. At least 100 l (corresponding to 200 kWh) of methanol, preferably 200 l (corresponding to 400 kWh), and particularly preferably 500 l (corresponding to 1000 kWh) are fed to the tank 6. The volume of the tank is dimensioned so that at least 10 charging processes (tank contents 100 l) are possible. The tank volume can be adjusted according to the requirements, which are determined by the location at which the charging column is erected. It is thus practical, for example, to choose a small tank volume in large cities, because the infrastructure for refilling is good and the charging column can thus be refilled very quickly. In rural areas, a larger tank volume is chosen in order to increase the intervals between the individual refill processes. Preferred tank volumes here are 2000 l, 10,000 l, or also 20,000 l.

The charging process begins when a user plugs the electrical connection (charging cable) 10 into the corresponding socket of the motor vehicle to be charged. The control unit 5 detects this, and in the second method step 200 the fuel is fed from the tank 6 through the fuel pump 11 to the combustion engine 7 and the engine is started by means of a starter. The starter and fuel pump 11 are supplied here with energy by the energy store 9. In the third method step 300, the combustion engine 7 drives the generator 8; the chemical energy stored in the fuel is thus converted into kinetic energy and in the fourth method step 400 into electrical energy. This electrical energy is output to the motor vehicle via the charging cable 10 in the fifth method step 500. The charging process ends when the user releases the charging cable 10 from the motor vehicle, or when the energy store of the motor vehicle is charged sufficiently (e.g., 80% of the capacity of the energy store or more). After the charging process is terminated, the combustion engine 7 is stopped and no more fuel is conveyed to the combustion engine 7. The charging column 1 enters a standby mode until the beginning of the next charging process.

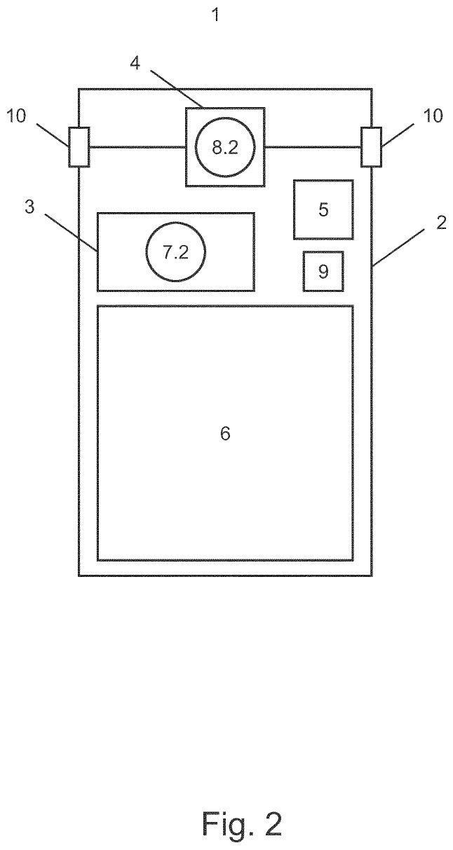

FIG. 2 shows an exemplary embodiment of the charging column according to the invention which generates current for charging a motor vehicle by means of a fuel cell 7. The charging column 1 has a fuel cell 7, which is installed inside the first device for energy conversion 3. The fuel cell 7 is usually a direct methanol fuel cell (DMFC), which is operated by means of methanol. However, other embodiments of the fuel cell 7 which are operated, for example, by means of ethanol, biogas, or hydrogen are also possible. All of these types of fuel can be produced in an environmentally friendly way from biomass or from natural gas, have long been established as fuels worldwide, and are thus affordably available.

In particular transporting and storing the liquid fuels (methanol, ethanol) as well as their operation in fuel cells are comparable to conventional gasoline (for motor vehicles) and therefore unproblematic. The fuel is stored in the charging column 1 according to the invention in a tank 6. The fuel cell 7 usually consists of multiple stacks of individual fuel cells and can thus be adjusted to the desired output of the charging column 1.

Furthermore, an electrical energy store (rechargeable battery) 9 and a device for conveying the liquid energy carrier 11 are installed in the charging column 1. The energy store 9 supplies the control unit 5, by means of which the charging column 1 detects and initializes the beginning and the termination of a charging process. In addition, a user can pay for the charging process by means of the control unit 5. Various payment systems are possible here, for example, via various credit cards or via a mobile end device, e.g., a smartphone.

The electrical energy store 9 starts via the fuel pump 11, which conveys the fuel into fuel cell 7, at the beginning of a charging process. The direct current generated in the fuel cell 7 is converted into direct current with a minimum voltage by means of the inverter 8. The electrical energy store 9 is recharged, if applicable, by the electrical energy generated by the generator 8. The electrical energy generated in the charging column 1 is output to a motor vehicle via one or more electrical connections 10 (charging cables).

The first and the second device for energy conversion 3, 4 with the fuel cell 7 and inverter 8, tank 6, energy store 9, the fuel pump 11, control unit 5, and the electrical connections 10 are all advantageously installed in a housing 2. As described, the charging column 1 is to be operated fully independently, i.e., it does not require an electrical connection to an existing power grid. The required electrical energy for its operation is delivered by the rechargeable energy store 9. The dimensions of the charging column 1 are also very compact; the fuel pump 6 usually takes up the most space. By suitably choosing the size of the tank 6, the dimensions of the charging column 1 can be kept small.

The method according to the invention for generating a charging current for charging electric vehicles has five method steps: In the first method step 100, a liquid energy carrier is fed into a tank 6 arranged in a housing. The tank 6 is filled by means of a filling vehicle. The charging process begins when a user plugs the electrical connection (charging cable) 10 into the corresponding socket of the motor vehicle to be charged. The control unit 5 detects this, and in the second method step 200 the fuel is fed from the tank 6 through the fuel pump 11 to the fuel cell 7. The fuel pump 11 is supplied here with energy by the energy store 9. In the third method step 300, the fuel cell 7 generates a direct current; in the fourth method step 400, the direct current is converted into a direct current with a minimum voltage (e.g., 230 V or 920 V) by the power converter 8. This direct current is output to the motor vehicle via the charging cable 10 in the fifth method step 500. The charging process ends when the user releases the charging cable 10 from the motor vehicle, or when the energy store of the motor vehicle is charged sufficiently (e.g., 90% of the capacity of the energy store or more). After the charging process is terminated, the operation of the fuel cell 7 is stopped and no more fuel is conveyed to the fuel cell 7. The charging column 1 enters a standby mode until the beginning of the next charging process.

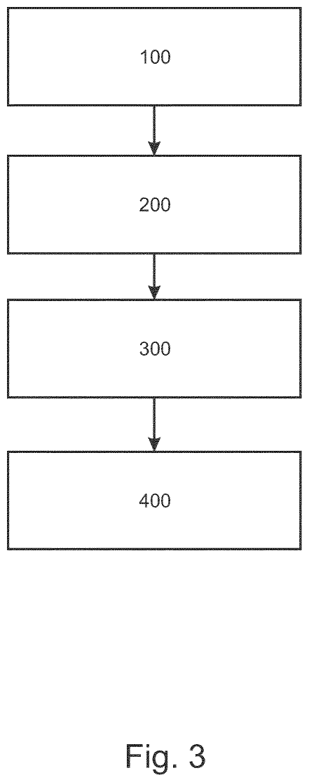

FIG. 3 shows the method according to the invention for generating a charging current for charging electric vehicles. The method according to the invention by means of the charging column 1 according to the invention has five method steps: In the first method step 100, a liquid energy carrier is fed into a tank 6 arranged in a housing. The charging process begins when a user plugs the electrical connection (charging cable) 10 into the corresponding socket of the motor vehicle to be charged. The control unit 5 detects this, and in the second method step 200 the fuel is fed from the tank 6 through the fuel pump 11 to the fuel cell 7 or respectively the combustion engine 7 and the engine is started by means of a starter. The fuel pump 11 is supplied here with energy by the energy store 9. In the third method step 300, the fuel cell 7 generates a direct current or respectively the combustion engine 7 drives the generator 8. In the fourth method step 400, the direct current which is generated by the fuel cell 7 is converted into direct current with a minimum voltage by the power converter 8. If a combustion engine 7 is present, the combustion engine 7 drives the generator 8; the chemical energy stored in the fuel is thus converted into kinetic energy and in the fourth method step 400 into electrical energy.

This current is output to the motor vehicle via the charging cable 10 in the fifth method step 500. The charging process ends when the user releases the charging cable 10 from the motor vehicle, or when the energy store of the motor vehicle is charged sufficiently (e.g., 75% of the capacity of the energy store or more). After the charging process is terminated, the combustion engine 7 is stopped and no more fuel is conveyed to the combustion engine 7. The charging column 1 enters a standby mode until the beginning of the next charging process.

### LIST OF REFERENCE NUMBERS

1 Charging column
2 Housing
3 First device for energy conversion
4 Second device for energy conversion
5 Control unit
6 Tank
7 Fuel cell/combustion engine
8 Power converter/generator
9 Energy store
10 Electrical connection
11 Device for conveying the liquid energy carrier
100 Feeding a liquid energy carrier into the tank
200 Transporting a liquid energy carrier from the tank to the first device for energy conversion
300 Converting the liquid energy carrier into a kinetic or electrical energy
400 Converting the kinetic or electrical energy into a direct current
500 Charging an electric vehicle

1. A method for generating a charging current for charging electric vehicles, comprising:
feeding (100) a liquid energy carrier into a tank (6) arranged in a housing (2) of a charging column (1),
feeding (200) a liquid energy carrier from a tank (6) arranged in a housing (2) of a charging column (1) to a first device for energy conversion (3), wherein the first device for energy conversion (3) is also arranged in the housing (2),
converting (300) of the liquid energy carrier into a kinetic or an electrical energy by the first device for energy conversion (3), and
outputting (500) the electrical energy to an electric vehicle in the form of a current.

2. The method for generating a charging current for charging electric vehicles of claim 1, further comprising:
converting (400) of the kinetic or the electrical energy into a direct current by a second device for energy conversion (4).

3. The method for generating a charging current for charging electric vehicles of claim 1, wherein a device for conveying the liquid energy carrier (11) to the first device for energy conversion (3) is started by the charging of an electrical energy store (9).

4. The method for generating a charging current for charging electric vehicles of claim 1, wherein the liquid energy carrier is fed (200) to the first device for energy conversion (3) by the charging of an electrical energy store (9).

5. The method for generating a charging current for charging electric vehicles of claim 1, wherein electrical energy is transported exclusively from the charging column (1) outward.

6. The method for generating a charging current for charging electric vehicles of claim 1, wherein the generation of the electrical energy in the charging column (1) starts with the beginning of a charging process and/or the generation of the electrical energy in the charging column (1) ends with the termination of a charging process.

7. The method for generating a charging current for charging electric vehicles of claim 1, wherein the feeding (200) of a liquid energy carrier from a tank (6) arranged in a housing (2) of a charging column (1) to a first device for energy conversion (3) does not take place simultaneously with the feeding (100) of a liquid energy carrier into a tank arranged in a housing (2) of a charging column (1).

8. The method for generating a charging current for charging electric vehicles of claim 1, wherein during charging processes of electric vehicles, an energy of at least 125 kWh, preferably at least 440 kWh, and particularly preferably at least 2000 kWh is output between two processes for feeding (100) a liquid energy carrier into a tank (6) arranged in a housing (2) of a charging column (1).

9. The method for generating a charging current for charging electric vehicles of claim 1, wherein at least 100 l, preferably at least 200 l, and particularly preferably at least 500 l of liquid energy carrier are fed during a feeding (100) of a liquid energy carrier into a tank (6) arranged in a housing (2) of a charging column (1).
